(19) United States
(12) Patent Application Publication
(10) Pub. No.: US 2023/0114605 A1
(43) Pub. Date: Apr. 13, 2023

(54) SYSTEM FOR TORQUE MEASUREMENT AND METHOD

(71) Applicant: Robert Bosch GmbH, Stuttgart (DE)

(72) Inventors: Adrian Kussmann, Filderstadt (DE); Christoph Ossmann, Reutlingen (DE); Frank Schatz, Kornwestheim (DE); Michael Zegowitz, Tuebingen (DE); Sven Schickle, Tuebingen (DE)

(21) Appl. No.: 17/913,245

(22) PCT Filed: Mar. 10, 2021
(86) PCT No.: PCT/EP2021/056062

§ 371 Date: Sep. 21, 2022

(30) Foreign Application Priority Data
Mar. 26, 2020 (DE) 10 2020 203 914.3

(51) Int. Cl. G01L 3/10; B62J 45/411

(52) U.S. Cl. CPC G01L 3/102; B62J 45/411

(57) ABSTRACT

The invention relates to a system for torque measurement, in particular at a drive of an e-bike, including at least one shaft which is rotatable about an axis, is magnetized in at least one axial partial section, and onto which a torque to be measured can be applied, at least one TMR sensor, which is situated outside the shaft and is designed for at least two-dimensionally, in particular three-dimensionally, measuring a magnetic field and which is arranged in relation to the at least one partial section in such a way that, when the shaft rotates about the axis, the at least one sensor measures a change of the magnetic field due to the magnetostrictive effect in the magnetized partial section when the torque acts on the shaft, and an evaluation unit, which is connected to the at least one TMR sensor and is designed for determining a torque acting on the shaft based on the measured values of the magnetic field.

### FIELD

The present invention relates to a system for torque measurement, in particular at a drive of an e-bike.

Moreover, the present invention relates to a method for torque measurement, in particular at a drive of an e-bike.

Although the present invention is applicable, in general, to arbitrary torque measurements, the present invention is explained with respect to torque measurements at a drive of an e-bike.

### BACKGROUND INFORMATION

With respect to e-bike drives, it has become conventional for e-bike drives to quickly and precisely measure the torque generated by the rider of the e-bike in the drive unit. In a conventional way, the magnetic flux which breaks out of its magnetized shaft loaded with torque by the rider of the e-bike may be measured with the aid of a magnetic field sensor in the form of a coil. Due to the anisotropy generated as a result of the torque due to the magnetostrictive effect, the magnetic field or the magnetic flux “breaks out” of the shaft. A problem in this case is that external magnetic fields, i.e., interfering magnetic fields, and the internal magnetic field arising due to the torque, i.e., the useful field, cannot be differentiated.

A method for determining torque is described in U.S. Pat. Application Publication No. US 2014/360285 A1, by which a third magnetic track is introduced and an appropriate gradient may be detected and compensated for, piece by piece, in the profile of the measured magnetic field, for example, with the aid of an additional interconnection of the coils functioning as magnetic field sensors, so that interference fields may be differentiated from useful fields. However, this requires more installation space due to the additional system of coils. In addition, only one of the three spatial directions of the magnetic field is measurable in each case with the aid of the coils.

A method for determining torque is described in U.S. Pat. Application Publication No. US 2013/125669 A1, the sensors in the form of coils being connected differently. As a result, an intermittent addition or subtraction of the useful field, i.e., the cancellation of the useful field, is possible. One of the problems in this case, however, is that torque cannot be measured during a certain period of time. Since a temporal offset also exists between the measurement of the useful field and the interference field and, on the other hand, the interference field, it is possible that the torque is inaccurately ascertained.

In addition, a magnetoelastic torque sensor is described in European Patent Application No. EP 3 364 163 A1. The magnetoelastic torque sensor includes a shaft, which is magnetized in a first axial section in a first circumferential direction and onto which a torque to be measured can be applied, and a first magnetic field sensor for detecting a magnetic field outside the shaft, which is generated by the first section of the shaft and depends on the applied torque, the first magnetic field sensor including a first 3D AMR sensor.

### SUMMARY

In one specific embodiment, the present invention provides a system for torque measurement, in particular at a drive of an e-bike, including at least one shaft which is rotatable about an axis, is magnetized in at least one axial partial section, and onto which a torque to be measured can be applied, at least one TMR sensor, which is arranged outside the shaft and is designed for at least two-dimensionally, in particular three-dimensionally, measuring a magnetic field and which is arranged in relation to the at least one partial section in such a way that, when the shaft rotates about the axis, the at least one TMR sensor measures a change of the magnetic field due to the magnetostrictive effect in the magnetized partial section when the torque acts on the shaft, and an evaluation unit, which is connected to the at least one TMR sensor and is designed for determining a torque acting on the shaft based on the measured values of the magnetic field.

In one further specific embodiment, the present invention provides a method for torque measurement, in particular at a drive of an e-bike, including the steps:
magnetizing at least one axial partial section of at least one shaft which is rotatable about an axis,
rotating the shaft about its axis,
at least two-dimensionally, in particular three-dimensionally, measuring a change of a magnetic field in the magnetized partial section due to the magnetostrictive effect during the rotation of the shaft about the axis with the aid of at least one TMR sensor, and
evaluating the measured values of the at least one TMR sensor with the aid of an evaluation unit, and
determining a torque acting on the shaft on the basis of the evaluated values.

One of the advantages achieved therewith is that, with the aid of the at least one at least two-dimensionally measuring TMR sensor, interference and useful fields are reliably differentiated and, thereby, the measurement of the torque is considerably improved. One further advantage is that the “blind time,” i.e., the temporal offset between the measurement of the useful field and the interference field, on the one hand, and the interference field on the other hand, is dispensed with. In addition, the system and the method are more robust with respect to external or interference fields. Moreover, the sensors are designable to be smaller, so that installation space may be saved.

Further features, advantages, and further specific embodiments of the present invention are described in the following or become apparent as a result of the disclosure herein.

According to one advantageous refinement of the present invention, the shaft includes at least two axial partial sections, which are magnetized. Therefore, the reliability of the measurement is increased, since different areas may be measured and interferences and measuring errors may be averaged out.

According to one further advantageous refinement of the present invention, the at least two axial partial sections have different magnetization, in particular opposite magnetization. Therefore, the reliability of the torque measurement may be further increased.

According to one further advantageous refinement of the present invention, multiple sensors, in particular multiple TMR sensors, are arranged and at least one sensor for measuring is assigned to each partial section. The advantage thereof is that a torque measurement may be even more reliably carried out. External interference fields may be even more reliably recognized and measuring errors may be, for example, averaged out.

According to one further advantageous refinement of the present invention, the two axial partial sections are arranged adjacent to each other. Therefore, the installation space necessary for the torque measurement may be reduced.

According to one further advantageous refinement of the present invention, the at least one sensor assigned to the particular axial partial section is arranged axially centrally with respect to the particular axial partial section. This enables a reliable measurement of the magnetic fields caused by the torque due to the magnetostrictive effect.

According to one further advantageous refinement of the present invention, the sensors assigned to at least two adjacent partial sections are arranged closer to one another in the axial direction than the sum of the halves of the particular axial extensions of the adjacent partial sections. Therefore, the installation space may be further reduced. In addition, external interference fields may be even more reliably recognized and taken into account in the measurement of the torque.

According to one further advantageous refinement of the present invention, the at least one TMR sensor is provided in the form of an ASIC. Therefore, a simple and continuous access to the measured values of the TMR sensor is possible, so that the torque may be ascertained based on the measured values, for example, with the aid of software. Due to the use of a magnetic field sensor, in particular a 3D magnetic field sensor, including a standalone evaluation unit in the form of an ASIC, for measuring the resultant magnetic field, the torque signal including the interference signal may be detected and, thereafter, the interference signal may be calculated, so that, thereafter, the pure useful signal in the form of the torque signal without the interference signal may be ascertained, without a blind time being present. Due to the use of a 3D magnetic field sensor, the outer magnetic field may be better determined via a vector-based observation. Due to the use of small magnetic field sensor elements in comparison to relatively larger coils, the magnetic field may be detected in a punctiform and, in particular, vectorial manner, in order to minimize the gradient acting due to outer interference fields.

Further important features and advantages of the present invention result from the disclosure herein.

It is understood that the features, which are mentioned above and which will be described in greater detail in the following, are usable not only in the particular combination indicated, but also in other combinations or alone, without departing from the scope of the present invention.

Preferred embodiments and specific embodiments of the present invention are represented in the figures and are explained in greater detail in the following description, identical reference numerals relating to identical or similar or functionally identical components or elements.

### BRIEF DESCRIPTION OF THE DRAWINGS

FIG. 1 shows a schematic representation of a conventional system.

FIG. 2 shows a schematic representation of a system according to one specific example embodiment of the present invention.

FIG. 3 shows a schematic representation of a system according to one specific example embodiment of the present invention.

FIG. 4 shows a schematic representation of steps of a method according to one specific example embodiment of the present invention.

### DETAILED DESCRIPTION OF EXAMPLE EMBODIMENTS

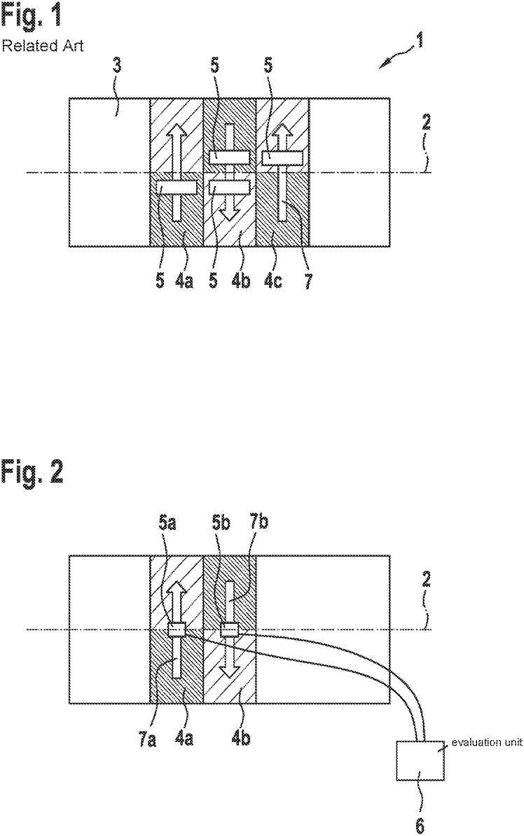

FIG. 1 shows a conventional system.

In detail, FIG. 1 shows a system 1, which includes a shaft 3, which is rotatable about an axis 2. Moreover, shaft 3 includes three adjacent axial partial sections 4a, 4b, 4c in the circumferential direction, adjacent areas 4a, 4b and 4b, 4c having opposite magnetization 7 in the circumferential direction of shaft 3. A measuring coil 5 is assigned to each of the two axially outer axial partial sections 4a, 4c, each of these measuring coils 5 being located at the same vertical level, i.e., distance to axis 2 of shaft 3, as a measuring coil 5 of central axial partial section 4b.

FIG. 2 shows a system according to one specific example embodiment of the present invention.

In detail, FIG. 2 essentially shows a system 1 according to FIG. 1, but in contrast to system 1 according to FIG. 1, system 1 according to FIG. 2 includes only two adjacent axial partial sections 4a, 4b, these having opposite magnetization 7a, 7b in the circumferential direction of shaft 3. Assigned to the two axial partial sections 4a, 4b is a 3D magnetic field sensor 5a, 5b, respectively, in the form of a TMR sensor, each of which is arranged in the axial center of particular axial partial section 4a, 4b. The two 3D magnetic field sensors 5a, 5b are also connected to an evaluation unit 6, which is designed for ascertaining, in a conventional way, the torque acting on shaft 3 based on the measured values of the magnetic field of the two sensors 5a, 5b.

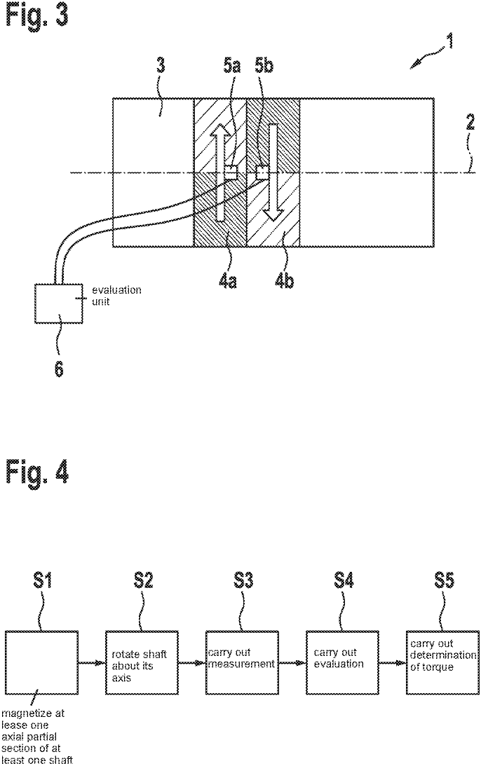

FIG. 3 shows a system according to one specific example embodiment of the present invention.

In detail, FIG. 3 essentially shows a system 1 according to FIG. 2, but in contrast to system 1 according to FIG. 2, in system 1 according to FIG. 3, the two 3D magnetic field sensors 5a, 5b are arranged as close to each other as possible, i.e., essentially at the shared boundary between the two axial partial sections 4a, 4b. This arrangement corresponds to an arrangement of magnetic field sensors 5a and 5b offset toward the center with respect to partial sections 4a and 4b. Therefore, it is possible to optimize the acting gradient in the profile of the magnetic field between the two measuring sites of external interference fields and the distance outward to possible attachments.

FIG. 4 shows steps of a method according to one specific example embodiment of the present invention.

In detail, FIG. 4 shows steps of a method for torque measurement, in particular at a drive of an e-bike. This includes the following steps:

In a first step S1, at least one axial partial section of at least one shaft, which is rotatable about an axis, is magnetized.

In one further step S2, the shaft is rotated about its axis.

In one further step S3, an at least two-dimensional, in particular three-dimensional, measurement is carried out of a change of a magnetic field in the magnetized partial section due to the magnetostrictive effect during the rotation of the shaft about the axis with the aid of at least one TMR sensor.

In one further step S4, an evaluation is carried out, with the aid of an evaluation unit, of the measured values of the at least one TMR sensor and, in one further step S5, a determination of a torque acting on the shaft is carried out on the basis of the evaluated values.

In summary, at least one of the specific embodiments of the present invention has at least one of the following advantages:
less installation space
a more precise determination of the torque acting on the shaft
a continuous determination of the torque acting on the shaft
greater flexibility with respect to the arrangement of attachments.

Although the present invention was described on the basis of preferred exemplary embodiments, it is not limited thereto. Instead, the present invention is modifiable in various ways.

1-9. (canceled)

10. A system for torque measurement at a drive of an e-bike, comprising:
at least one shaft, which is rotatable about an axis, magnetized in at least one axial partial section, and onto which a torque to be measured can be applied;
at least one TMR sensor arranged outside the shaft, and configured to measure, at least two-dimensionally, a magnetic field and which is arranged in relation to the magnetized at least one axial partial section in such a way that, when the shaft rotates about the axis, the at least one TMR sensor measures a change of the magnetic field due to the magnetostrictive effect in the magnetized at least on axial partial section when the torque acts on the shaft; and
an evaluation unit connected to the at least one TMR sensor, and configured to determine a torque acting on the shaft based on measured values of the magnetic field.

11. The system as recited in claim 10, wherein the TMR sensor is configured to measure the magnetic field three-dimensionally.

12. The system as recited in claim 10, wherein the shaft includes at least two axial partial sections, which are magnetized.

13. The system as recited in claim 12, wherein the at least two axial partial sections have different magnetizations.

14. The system as recited in claim 12, wherein the at least two axial partial sections have opposite magnetizations.

15. The system as recited in claim 12, wherein the at least one TMR sensor includes multiple TMR sensors, at least one of the TMR sensors being assigned to each respective partial section of the at least two partial sections.

16. The system as recited in claim 12, wherein the at least two axial partial sections are arranged adjacent to each other.

17. The system as recited in claim 15, wherein each the at least one TMR sensors assigned to the respective axial partial sections is arranged axially centrally with respect to the respective axial partial section.

18. The system as recited in claim 15, wherein sensors of the multiple TMR sensor assigned to at least two adjacent partial sections are arranged closer to one another in an axial direction than a sum of the halves of axial extensions of the at least two adjacent partial sections.

19. The system as recited in claim 10, wherein the at least one TMR sensor is an ASIC.

20. A method for torque measurement at a drive of an e-bike, comprising the following steps:
magnetizing at least one axial partial section of at least one shaft which is rotatable about an axis;
rotating the shaft about the axis;
at least two-dimensionally measuring a change of a magnetic field in the magnetized at least one axial partial section using at least one TMR sensor, the change of the magnetic field being due to a magnetostrictive effect during the rotation of the shaft about the axis;
evaluating measured values of the at least one TMR sensor using an evaluation unit; and
determining a torque acting on the shaft based on the evaluated measured values.
